(19) United States
(12) Patent Application Publication
(10) Pub. No.: US 2022/0250619 A1
(43) Pub. Date: Aug. 11, 2022

(54) TRAVELING ASSIST APPARATUS

(71) Applicant: Honda Motor Co., Ltd., Tokyo (JP)

(72) Inventor: Hayato Ikeda, Wako-shi (JP)

(21) Appl. No.: 17/592,450

(22) Filed: Feb. 3, 2022

(30) Foreign Application Priority Data
Feb. 10, 2021 (JP) 2021-019589

(51) Int. Cl. B60W 30/12

(52) U.S. Cl. CPC B60W 30/12; B60W 2556/40; B60W 2552/53

(57) ABSTRACT

A traveling assist apparatus configured to support traveling of a vehicle traveling on a predetermined route along a target path, includes: a processor and a memory connected to the processor. The memory is configured to store a first map information of a first area and a second map information of a second area adjacent to the first area, including position information of lane marker defining a lane. The processor is configured to perform: generating a first target path of the vehicle in the first area based on the first map information stored in the memory and generating a second target path of the vehicle in the second area based on the second map information stored in the memory; and correcting the first target path in a boundary area between the first area and the second area based on the second target path.

### CROSS-REFERENCE TO RELATED APPLICATION

This application is based upon and claims the benefit of priority from Japanese Patent Application No. 2021-019589 filed on Feb. 10, 2021, the content of which is incorporated herein by reference.

### BACKGROUND OF THE INVENTION

### Field of the Invention

This invention relates to a traveling assist apparatus configured to support traveling of a vehicle.

### Description of the Related Art

As this type of apparatus, conventionally, an apparatus that sets a target path of a vehicle that performs automatic driving is known (for example, see Japanese Unexamined Patent Application Publication No. 2020-66333 (JP2020-066333A)). In the apparatus described in JP2020-066333A, the target path of the vehicle is set so as to pass through the center of the lane on the basis of map information provided in advance.

Meanwhile, the vehicle may travel in boundary regions of a plurality of maps adjacent to each other. However, since map information of adjacent maps may have an inherent error, when a target path is set as in the device described in JP2020-066333A, it may be difficult to smoothly set the target path when traveling in a boundary region of a plurality of maps.

### SUMMARY OF THE INVENTION

An aspect of the present invention is a traveling assist apparatus configured to support traveling of a vehicle traveling on a predetermined route along a target path, including: a processor and a memory connected to the processor. The memory is configured to store a first map information of a first area and a second map information of a second area adjacent to the first area, including position information of lane marker defining a lane. The processor is configured to perform: generating a first target path of the vehicle in the first area based on the first map information stored in the memory and generating a second target path of the vehicle in the second area based on the second map information stored in the memory; and correcting the first target path in a boundary area between the first area and the second area based on the second target path.

### BRIEF DESCRIPTION OF THE DRAWINGS

The objects, features, and advantages of the present invention will become clearer from the following description of embodiments in relation to the attached drawings, in which:

FIG. 1 is a diagram illustrating an example of a travel scene of an automated driving vehicle to which a traveling assist apparatus according to an embodiment of the embodiment of the present invention is applied;

FIG. 2 is a block diagram schematically illustrating an overall configuration of a vehicle control system of the automated driving vehicle to which the traveling assist apparatus according to the embodiment of the present invention is applied;

FIG. 3 is a diagram illustrating an example of a traveling scene of the automated driving vehicle assumed by the traveling assist apparatus according to the embodiment of the present invention;

FIG. 4 is a block diagram illustrating a configuration of a main part of the traveling assist apparatus according to the embodiment of the present invention;

FIG. 5A is a diagram illustrating an example of target paths before and after correction by the traveling assist apparatus according to the embodiment of the present invention;

FIG. 5B is a diagram illustrating another example of target paths before and after correction by the traveling assist apparatus according to the embodiment of the present invention;

FIG. 5C is a diagram illustrating another example of target paths before and after correction by the traveling assist apparatus according to the embodiment of the present invention; and

FIG. 6 is a flowchart illustrating an example of processing executed by a controller shown in FIG. 4.

### DETAILED DESCRIPTION OF THE INVENTION

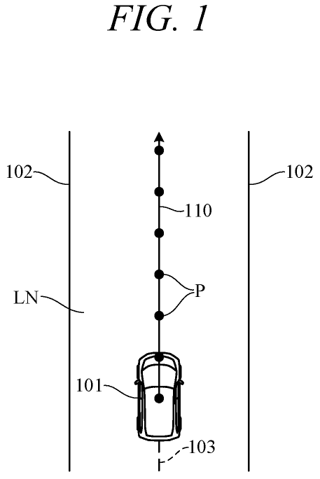

An embodiment of the present invention will be described below with reference to FIGS. 1 to 6. The traveling assist apparatus according to the embodiment of the present invention can be applied to a vehicle having an automatic driving function (automated driving vehicle). The automated driving vehicle includes not only a vehicle that performs only traveling in an automatic driving mode in which a driving operation by a driver is unnecessary, but also a vehicle that performs traveling in an automatic driving mode and traveling in a manual driving mode by a driving operation by a driver.

FIG. 1 is a diagram illustrating an example of a travel scene of an automated driving vehicle (hereinafter, a vehicle) 101. FIG. 1 illustrates an example in which the vehicle 101 travels (lane-keep travel) while following a lane so as not to deviate from a lane LN defined by dividing lines 102. Note that the vehicle 101 may be any of an engine vehicle having an internal combustion engine as a traveling drive source, an electric vehicle having a traveling motor as a traveling drive source, and a hybrid vehicle having an engine and a traveling motor as traveling drive sources.

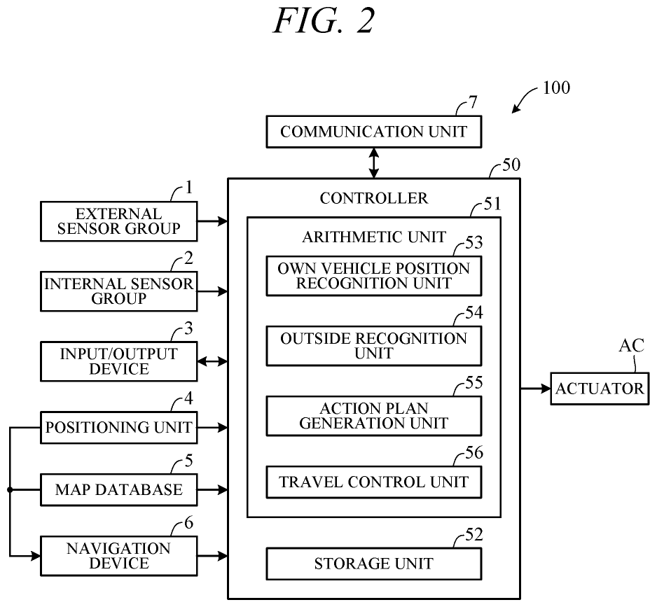

FIG. 2 is a block diagram schematically illustrating an overall configuration of a vehicle control system 100 of the vehicle 101 to which a traveling assist apparatus according to the present embodiment is applied. As illustrated in FIG. 2, the vehicle control system 100 mainly includes a controller 50, an external sensor group 1, an internal sensor group 2, an input/output device 3, a positioning unit 4, a map database 5, a navigation device 6, a communication unit 7, and a traveling actuator AC each electrically connected to the controller 50.

The external sensor group 1 is a generic term for a plurality of sensors (external sensors) that detect an external situation which is peripheral information of the vehicle 101 (FIG. 1). For example, the external sensor group 1 includes a LiDAR that measures scattered light with respect to irradiation light in all directions of the vehicle 101 and measures a distance from the vehicle 101 to a surrounding obstacle, a radar that detects another vehicle, an obstacle, or the like around the vehicle 101 by irradiating electromagnetic waves and detecting a reflected wave, and a camera that is mounted on the vehicle 101 and has an imaging element such as a CCD or a CMOS to image the periphery of the vehicle 101 (forward, aft and lateral).

The internal sensor group 2 is a generic term for a plurality of sensors (internal sensors) that detect a traveling state of the vehicle 101. For example, the internal sensor group 2 includes a vehicle speed sensor that detects the vehicle speed of the vehicle 101, an acceleration sensor that detects the acceleration in the front-rear direction and the acceleration (lateral acceleration) in the left-right direction of the vehicle 101, a rotation speed sensor that detects the rotation speed of the traveling drive source, a yaw rate sensor that detects the rotation angular speed around the vertical axis of the center of gravity of the vehicle 101, and the like. The internal sensor group 2 further includes a sensor that detects driver's driving operation in a manual driving mode, for example, operation of an accelerator pedal, operation of a brake pedal, operation of a steering wheel, and the like.

The input/output device 3 is a generic term for devices to which a command is input from a driver or from which information is output to the driver. For example, the input/output device 3 includes various switches to which the driver inputs various commands by operating an operation member, a microphone to which the driver inputs a command by voice, a display that provides information to the driver with a display image, a speaker that provides information to the driver by voice, and the like.

The positioning unit (GNSS unit) 4 has a positioning sensor that receives a positioning signal transmitted from a positioning satellite. The positioning satellite is an artificial satellite such as a GPS satellite or a quasi-zenith satellite. The positioning unit 4 measures a current position (latitude, longitude, altitude) of the vehicle 101 by using the positioning information received by the positioning sensor.

The map database 5 is a device that stores general map information used in the navigation device 6, and is constituted of, for example, a hard disk or a semiconductor element. The map information includes road position information, information on a road shape (curvature or the like), and position information on intersections and branch points. The map information stored in the map database 5 is different from highly accurate map information stored in a storage unit 52 of the controller 50.

The navigation device 6 is a device that searches for a target route on a road to a destination input by a driver and provides guidance along the target route. The input of the destination and the guidance along the target route are performed via the input/output device 3. The target route is calculated based on a current position of the vehicle 101 measured by the positioning unit 4 and the map information stored in the map database 5. The current position of the vehicle 101 can be measured using the detection values of the external sensor group 1, and the target route may be calculated on the basis of the current position and the highly accurate map information stored in the storage unit 52.

The communication unit 7 communicates with various servers (not illustrated) via a network including a wireless communication network represented by the Internet network, a mobile phone network, or the like, and acquires map information, traffic information, and the like from the servers periodically or at an arbitrary timing. The network includes not only a public wireless communication network but also a closed communication network provided for each predetermined management region, for example, a wireless LAN, Wi-Fi (registered trademark), Bluetooth (registered trademark), and the like. The acquired map information is output to the map database 5 and the storage unit 52, and the map information is updated.

The actuator AC is a traveling actuator for controlling traveling of the vehicle 101. When the traveling drive source is an engine, the actuator AC includes a throttle actuator that adjusts an opening degree of a throttle valve of the engine and an injector actuator that adjusts a valve opening timing and a valve opening time of the injector. When the traveling drive source is a traveling motor, the traveling motor is included in the actuator AC. The actuator AC also includes a brake actuator that operates the braking device of the vehicle 101 and a steering actuator that drives the steering device.

The controller 50 includes an electronic control unit (ECU). More specifically, the controller 50 includes a computer including an arithmetic unit 51 such as a CPU (microprocessor), the storage unit 52 such as a ROM and a RAM, and other peripheral circuits (not illustrated) such as an I/O interface. Although a plurality of ECUs having different functions such as an engine control ECU, a traveling motor control ECU, and a braking device ECU can be separately provided, in FIG. 2, the controller 50 is illustrated as a set of these ECUs for convenience.

The storage unit 52 stores highly accurate detailed road map information. The road map information includes road position information, information of a road shape (curvature or the like), information of a road gradient, position information of an intersection or a branch point, information of the number of lanes, width of a lane and position information for each lane (information of a center position of a lane or a boundary line of a lane position), position information of a landmark (traffic lights, signs, buildings, etc.) as a mark on a map, and information of a road surface profile such as unevenness of a road surface.

The map information stored in the storage unit 52 includes map information acquired from the outside of the vehicle 101 via the communication unit 7, for example, information of a map (referred to as a cloud map) acquired via a cloud server, and information of a map created by the vehicle 101 itself using detection values by the external sensor group 1, for example, information of a map (referred to as an environmental map) including point cloud data generated by mapping using a technology such as simultaneous localization and mapping (SLAM).

The cloud map information is general-purpose map information generated on the basis of data collected by a dedicated surveying vehicle or a general automated driving vehicle traveling on a road, and distributed to the general automated driving vehicle via a cloud server. The cloud map is generated for an area with a large traffic volume such as a highway or an urban area, but is not generated for an area with a small traffic volume such as a residential area or a suburb. On the other hand, the environmental map information is dedicated map information generated on the basis of data collected by each automated driving vehicle traveling on a road and used for automatic driving of the vehicle. The storage unit 52 also stores information such as various control programs and a threshold used in the programs.

The arithmetic unit 51 includes an own vehicle position recognition unit 53, an outside recognition unit 54, an action plan generation unit 55, and a travel control unit 56 as functional configurations. In other words, the arithmetic unit 51 such as a CPU (microprocessor) of the controller 50 functions as the own vehicle position recognition unit 53, outside recognition unit 54, action plan generation unit 55, and travel control unit 56.

The own vehicle position recognition unit 53 highly accurately recognizes the position of the vehicle 101 on the map (own vehicle position) on the basis of the highly accurate detailed road map information (cloud map information, environmental map information) stored in the storage unit 52 and the peripheral information of the vehicle 101 detected by the external sensor group 1. When the own vehicle position can be measured by a sensor installed on the road or outside a road side, the own vehicle position can be recognized by communicating with the sensor via the communication unit 7. The own vehicle position may be recognized using the position information of the vehicle 101 obtained by the positioning unit 4.

The outside recognition unit 54 recognizes an external situation around the vehicle 101 based on the signal from the external sensor group 1 such as a LiDAR, a radar, and a camera. For example, the position, speed, and acceleration of a surrounding vehicle (a front vehicle or a rear vehicle) traveling around the dividing lines 102 of the lane LN on which the vehicle 101 travels or around the vehicle 101, the position of a surrounding vehicle stopped or parked around the vehicle 101, and the positions and states of other objects are recognized. Other objects include signs, traffic lights, road stop lines, buildings, guardrails, utility poles, signboards, pedestrians, bicycles, and the like. The states of other objects include a color of a traffic light (red, green, yellow), the moving speed and direction of a pedestrian or a bicycle, and the like.

The action plan generation unit 55 generates a traveling path (target path) of the vehicle 101 from a current point of time to a predetermined time ahead based on, for example, the target route calculated by the navigation device 6, the own vehicle position recognized by the own vehicle position recognition unit 53, and the external situation recognized by the outside recognition unit 54. More specifically, the target path of the vehicle 101 is generated on the cloud map or the environmental map on the basis of highly accurate detailed road map information (cloud map information, environmental map information) stored in the storage unit 52. When there are a plurality of paths that are candidates for the target path on the target route, the action plan generation unit 55 selects, from the plurality of paths, an optimal path that satisfies criteria such as compliance with laws and regulations and efficient and safe traveling, and sets the selected path as the target path. Then, the action plan generation unit 55 generates an action plan corresponding to the generated target path.

The action plan includes travel plan data set for each unit time (for example, 0.1 seconds) from a current point of time to a predetermined time (for example, 5 seconds) ahead, that is, travel plan data set in association with a time for each unit time. The travel plan data includes position data of the vehicle 101 and vehicle state data for each unit time. The position data is, for example, data indicating a two-dimensional coordinate position on the road, and the vehicle state data is vehicle speed data indicating the vehicle speed, direction data indicating the direction of the vehicle 101, or the like. Therefore, when the vehicle is accelerated to the target vehicle speed within the predetermined time, the data of the target vehicle speed is included in the action plan. The vehicle state data can be obtained from a change in position data per unit time. The travel plan is updated every unit time.

FIG. 1 illustrates an example of the action plan generated by the action plan generation unit 55, that is, a travel plan of a scene in which the vehicle 101 travels in the lane-keep travel so as not to deviate from the lane LN. Each point P in FIG. 1 corresponds to position data for each unit time from the current point in time to a predetermined time ahead, and the target path 110 is obtained by connecting these points P in time order. The target path 110 is generated, for example, along the center line 103 of the pair of dividing lines 102 defining the lane LN. The target path 110 may be generated along a past travel path included in the map information. Note that the action plan generation unit 55 generates various action plans corresponding to overtaking travel in which the vehicle 101 moves to another lane and overtakes the preceding vehicle, lane change travel in which the vehicle moves to another lane, deceleration travel, acceleration travel, or the like, in addition to the lane-keep travel. When generating the target path 110, the action plan generation unit 55 first determines a travel mode and generates the target path 110 on the basis of the travel mode. The information on the target path 110 generated by the action plan generation unit 55 is added to the map information and stored in the storage unit 52, and is taken into consideration when the action plan generation unit 55 generates an action plan at the time of the next travel.

In the automatic driving mode, the travel control unit 56 controls each of the actuators AC so that the vehicle 101 travels along the target path 110 generated by the action plan generation unit 55. More specifically, the travel control unit 56 calculates a requested driving force for obtaining the target acceleration for each unit time calculated by the action plan generation unit 55 in consideration of travel resistance determined by a road gradient or the like in the automatic driving mode. Then, for example, the actuator AC is feedback controlled so that an actual acceleration detected by the internal sensor group 2 becomes the target acceleration. That is, the actuator AC is controlled so that the vehicle 101 travels at the target vehicle speed and the target acceleration. In the manual driving mode, the travel control unit 56 controls each actuator AC in accordance with a travel command (steering operation or the like) from the driver acquired by the internal sensor group 2.

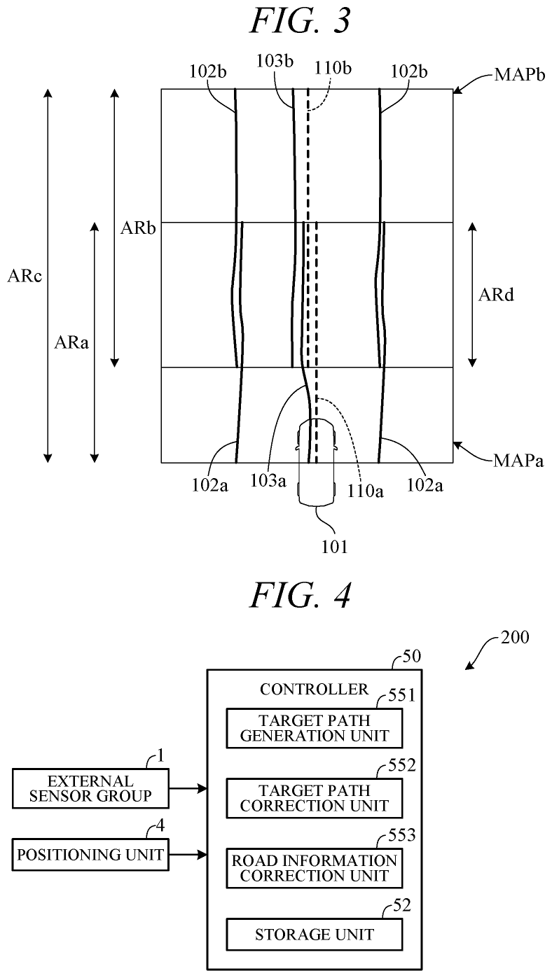

The traveling assist apparatus according to the present embodiment corrects a target path of an automated driving vehicle traveling in boundary regions of a plurality of maps adjacent to each other. FIG. 3 is a diagram illustrating an example of a traveling scene of the vehicle 101 assumed by the traveling assist apparatus according to the present embodiment, and illustrates a scene in which the vehicle 101 travels in the lane-keep travel so as not to deviate from the lane LN as in FIG. 1. Hereinafter, an area where the environmental map generated on the vehicle 101 side is stored in the storage unit 52 is referred to as an environmental map area ARa, and an area where the cloud map generated on the cloud server side is stored in the storage unit 52 is referred to as a cloud map area ARb.

Each piece of map information includes an inherent error due to a distance measurement error when the map is generated. Therefore, as illustrated in FIG. 3, the target path 110a of the vehicle 101 generated on the environmental map may not coincide with the target path 110b generated on the cloud map. When the vehicle travels in the automatic driving mode at the boundary area ARc which is the boundary region between the environmental map area ARa and the cloud map area ARb in a state where there is a deviation between the target paths 110a and 110b in this manner, there is a possibility that the target path 110 of the vehicle 101 cannot be smoothly set. More specifically, there is a possibility that the target path 110 cannot be smoothly set at the timing when the map information used for recognition of the own vehicle position by the own vehicle position recognition unit 53 is switched. Therefore, according to the present embodiment, the traveling assist apparatus is configured as follows so that the deviation of the target paths generated on the plurality of maps can be eliminated and the target path can be smoothly set when the vehicle travels in the boundary region.

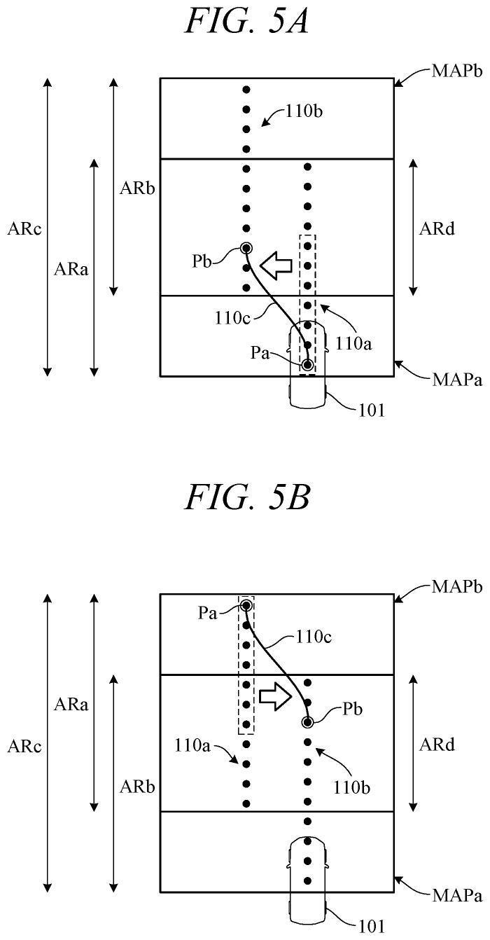

FIG. 4 is a block diagram illustrating a configuration of a main part of the traveling assist apparatus 200 according to the embodiment of the present invention. The traveling assist apparatus 200 assists the traveling operation of the vehicle 101 in the automatic driving mode, and constitutes a part of the vehicle control system 100 of FIG. 2. As illustrated in FIG. 4, the traveling assist apparatus 200 includes the controller 50, the external sensor group 1, and the positioning unit 4.

The controller 50 includes a target path generation unit 551, a target path correction unit 552, and a road information correction unit 553 as functional configurations carried by the arithmetic unit 51 (FIG. 2). In other words, the arithmetic unit 51 such as a CPU (microprocessor) of the controller 50 functions as the target path generation unit 551, the target path correction unit 552, and the road information correction unit 553. The target path generation unit 551, the target path correction unit 552, and the road information correction unit 553 are configured by, for example, the action plan generation unit 55 in FIG. 2. The storage unit 52 of FIG. 4 stores in advance the environmental map information of the environmental map area ARa and the cloud map information of the cloud map area ARb.

The target path generation unit 551 generates a target path 110a of the vehicle 101 on the environmental map (FIG. 3) on the basis of the peripheral information of the vehicle 101 detected by the external sensor group 1, the current position of the vehicle 101 measured by the positioning unit 4, and the environmental map information stored in the storage unit 52. In addition, the target path 110b of the vehicle 101 is generated on the cloud map on the basis of the cloud map information. The information of the target paths 110a and 110b generated by the target path generation unit 551 is added to the environmental map information and the cloud map information, respectively, and stored in the storage unit 52.

The target path correction unit 552 corrects the target path 110a on the environmental map in the boundary area ARc on the basis of the target path 110b on the cloud map (FIG. 3). In other words, since the cloud map information, which is general-purpose map information used by many automated driving vehicles including the vehicle 101, cannot be rewritten on the vehicle 101 side, the environmental map information on the vehicle 101 side is corrected on the basis of the cloud map information.

The target path correction unit 552 acquires information of the target paths 110a and 110b in the boundary area ARc generated by the target path generation unit 551, and associates the information of each lane LN when there are a plurality of lanes LN. More specifically, information of the dividing lines 102a and 102b, the center lines 103a and 103b, and the target paths 110a and 110b corresponding to the respective lanes LN is associated with each other. When the data formats of the dividing lines 102a and 102b, the center lines 103a and 103b, and the target paths 110a and 110b are different, they are unified. For example, in a case where one target path 110a is expressed by a coordinate value and the other target path 110b is expressed by a function, these are unified to the coordinate values.

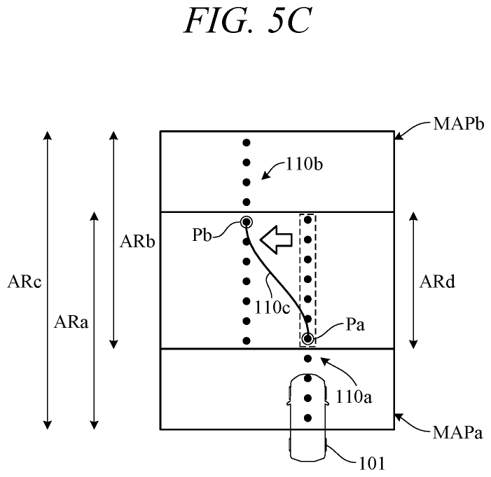

FIGS. 5A to 5C are diagrams illustrating an example of the target paths 110 before and after correction by the target path correction unit 552, and illustrate the target paths 110a and 110b expressed by coordinate values before correction and a target path 110c expressed by a function after correction.

As illustrated in FIG. 5A, the target path correction unit 552 corrects a part (broken line part in the drawing) of the target path 110a on the environmental map as an approximate curve passing through a point Pa on the target path 110a and a point Pb on the target path 110b on the cloud map. In other words, an approximate curve having the point Pa on the target path 110a as a start point and the point Pb on the target path 110b as an end point is generated as the corrected target path 110c. The approximate curve is expressed by a function such as a Bézier curve or a B-spline curve with a point group between the point Pa and the point Pb as a control point, for example. As a result, the target path 110a on the environmental map and the target path 110b on the cloud map are smoothly connected via the corrected target path 110c without interruption.

When the vehicle 101 travels from the environmental map area ARa toward the cloud map area ARb as illustrated in FIG. 5A, for example, the current position (own vehicle position) of the vehicle 101 is set as a start point of the corrected target path 110c. With this configuration, the target path 110a on the environmental map is corrected in advance as the target path 110c before the vehicle 101 actually travels and is connected to the target path 110b on the cloud map, so that the traveling operation of the vehicle 101 at the boundary area ARc can be appropriately supported.

In addition, any point included in the overlapping area ARd of the environmental map area ARa and the cloud map area ARb, for example, the point Pb on the target path 110b, which is predetermined distance ahead of an edge of the cloud map area ARb, is set as the end point of the corrected target path 110c. The predetermined distance is set to a distance at which the own vehicle position can be stably recognized according to the vehicle speed of the vehicle 101 and the like after the map information used for the recognition of the own vehicle position by the own vehicle position recognition unit 53 is switched to the cloud map information.

When the vehicle 101 travels from the cloud map area ARb toward the environmental map area ARa as illustrated in FIG. 5B, for example, the point Pa on the target path 110a, which is at a predetermined distance ahead of an edge of the cloud map area ARb, is set as the end point of the corrected target path 110c. The predetermined distance in this case is set to a distance sufficient to eliminate the deviation between the assumed target paths 110a and 110b and gently set the corrected target path 110c. The predetermined distance may be set according to the vehicle speed of the vehicle 101 or the like. As a start point of the corrected target path 110c, the point Pb on the target path 110b included in the overlapping area ARd is set.

As illustrated in FIG. 5C, the target path correction unit 552 may correct the target path 110a in the overlapping area ARd. In this case, the target path correction unit 552 generates the corrected target path 110c with the point Pa at the end of the cloud map area ARb on the target path 110a as the start point and the point Pb at the end of the environmental map area ARa on the target path 110b as the end point. As a result, the corrected target path 110c can be smoothly set using the overlapping area ARd.

The road information correction unit 553 corrects the position information of the dividing line 102a and the center line 103a included in the environmental map information stored in the storage unit 52 according to the correction result by the target path correction unit 552. More specifically, the position information of the dividing line 102a and the center line 103a in the boundary area ARc is corrected using a function similar to the corrected target path 110c generated by the target path correction unit 552. As a result, it is possible to prevent a malfunction such as a road-departure-mitigation function performed on the basis of the position information of the dividing line 102a and the center line 103a.

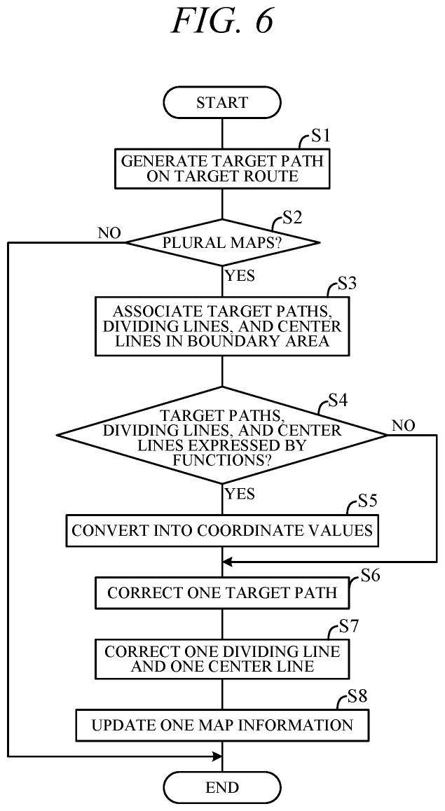

FIG. 6 is a flowchart illustrating an example of processing executed by the controller 50 of FIG. 4. The processing illustrated in this flowchart is started, for example, when the automatic driving mode of the vehicle 101 is turned on, and is repeated at a predetermined cycle until the automatic driving mode is turned off. First, in S1 (S: processing step), the target path 110 is generated on the target route. Next, in S2, it is determined whether or not there is a boundary area ARc of a plurality of maps along the target path 110 generated in S1. When the determination result is positive in S2, the process proceeds to S3, and when the determination result is negative, the process ends.

In S3, pieces of information of the target paths 110a and 110b, the dividing lines 102a and 102b, and the center lines 103a and 103b on the maps corresponding to the lanes LN in the boundary area ARc are associated with one another. Next, in S4, it is determined whether or not the target paths 110a and 110b, the dividing lines 102a and 102b, and the center lines 103a and 103b are expressed by functions. When the determination result is positive in S4, the process proceeds to S5 to convert the target paths 110a and 110b, the dividing lines 102a and 102b, and the center lines 103a and 103b into coordinate values, and the process proceeds to S6. On the other hand, when the determination result is negative in S4, S5 is skipped, and the process directly proceeds to S6.

In S6, the target path 110a of one map in the boundary area ARc is corrected on the basis of the target path 110b of the other map. Next, in S7, the dividing lines 102a and the center line 103a of one map in the boundary area ARc is corrected on the basis of the dividing line 102b and the center line 103b of the other map by a correction method similar to that in S6. Next, in S8, the information of the target path 110a, the dividing line 102a, and the center line 103a of one map, which is corrected in S6 and S7, is stored in the storage unit 52, the map information of the one map is updated, and the processing ends.

The operation of the traveling assist apparatus 200 according to the present embodiment is summarized as follows. As illustrated in FIG. 5A, when the vehicle 101 traveling from the environmental map area ARa toward the cloud map area ARb on the target route in the automatic driving mode approaches the boundary area ARc, the target path 110a is corrected to the target path 110c (S1 to S6 and S8 in FIG. 6). As a result, the vehicle 101 can smoothly travel along the boundary area ARc along the target paths 110a and 110b smoothly connected via the corrected target path 110c. In addition, since the dividing line 102a and the center line 103a (FIG. 3) are also corrected in accordance with the target path 110a (S7 and S8 in FIG. 6), it is possible to prevent malfunctions such as a road-departure-mitigation function performed on the basis of these pieces of position information.

The present embodiment can achieve advantages and effects such as the following:

(1) The traveling assist apparatus 200 is configured to support traveling of the vehicle 101 traveling on a predetermined route along the target path 110 (FIG. 1). The traveling assist apparatus 200 includes: the storage unit 52 configured to store the environmental map information of the environmental map area ARa and the cloud map information of the cloud map area ARb adjacent to the environmental map area ARa, including the position information of the lane markers 102 defining the lane LN; the target path generation unit 551 configured to generate the target path 110a of the vehicle 101 in the environmental map area ARa based on the environmental map information stored in the storage unit 52 and configured to generate the target path 110b of the vehicle 101 in the cloud map area ARb based on the cloud map information stored in the storage unit 52; and the target path correction unit 552 configured to correct the target path 110a in the boundary area ARc between the environmental map area ARa and the cloud map area ARb based on the target path 110b (FIG. 4).

As a result, since the plurality of target paths 110a and 110b generated on each of the plurality of maps are connected in the boundary area ARc in advance when the vehicle 101 travels in the boundary area ARc, the target path 110 when traveling in the boundary area ARc can be smoothly set.

(2) The accuracy of the cloud map information is higher than the accuracy of the environmental map information. For example, on the basis of more accurate cloud map information generated on the basis of travel data of more vehicles, the target path 110a of the environmental map information generated on the basis of only the travel data of each vehicle 101 is corrected. Therefore, the target path 110 for traveling in the boundary area ARc can be appropriately set.

(3) The environmental map information is a dedicated map information that can be used by the vehicle 101 only. The cloud map information is a general map information that can be used by the vehicle 101 and other vehicles. That is, the target path 110a of the environmental map information, which is dedicated map information for each individual vehicle 101, is corrected on the basis of the cloud map, which is general-purpose map information used by many automated driving vehicles including the vehicle 101 and cannot be rewritten on the individual vehicle 101 side.

(4) The target path correction unit 552 corrects a part of the first target path 110a as an approximate curve (the corrected target path 110c) passing through the point Pa on the target path 110a and the point Pb on the target path 110b (FIG. 5A to FIG. 5C). As a result, the target path 110a and the target path 110b can be smoothly connected without interruption.

(5) One of the point Pa and the point Pb is included in the overlapped area ARd between the environmental map area ARa and the cloud map area ARb (FIG. 5A to FIG. 5C). For example, the end point of the corrected target path 110c when entering the cloud map area ARb from the environmental map area ARa is set as the point Pb on the target path 110b a predetermined distance ahead of the end of the cloud map area ARb. In this case, even after the map information used to recognize the own vehicle position is switched to the cloud map information, the own vehicle position can be stably recognized.

(6) The point Pa is a point on the edge of the cloud map area ARb. The point Pb is a point on the edge of the environmental map area ARa (FIG. 5C). As a result, since the approximate curve (the corrected target path 110c) is generated in the overlapping area ARd between the environmental map area ARa and the cloud map area ARb, a smooth target path 110 can be set.

(7) The traveling assist apparatus 200 further includes: the road information correction unit 553 configured to correct the position information of the lane markers 102a stored in the storage unit 52 based on the correction result of the target path correction unit 552 (FIG. 4). As a result, it is possible to prevent a malfunction such as a road-departure-mitigation function performed based on the position information of the dividing line 102a and to support a smooth traveling operation of the vehicle 101 at the boundary area ARc.

The above embodiment may be modified into various forms. Hereinafter, some modifications will be described. In the above embodiment, an example of eliminating the deviation between the target paths 110a and 110b occurring between the environmental map information on the vehicle 101 side and the cloud map information on the cloud server side has been described. However, the first map information and the second map information are not limited to such information. For example, the deviation of the target path occurring between the environmental map information on the vehicle 101 side and the environmental map information acquired from another automated driving vehicle by inter-vehicle communication may be eliminated. The deviation of the target path occurring among the plurality of pieces of cloud map information may be eliminated.

In the above embodiment, the example in which the traveling assist apparatus 200 constitutes a part of the vehicle control system 100 has been described. However, the traveling assist apparatus is only required to assist the traveling operation of the automated driving vehicle, and is not limited to one mounted on the automated driving vehicle. For example, it may constitute a part of an operation management server, a traffic control server, or the like provided outside the automated driving vehicle.

In the above embodiment, the example in which the target path generation unit 551 generates the target paths 110a and 110b from the current point of time to the predetermined time ahead has been described, but the target path generation unit is not limited to such a configuration. For example, the target path in the boundary area may be generated every time each piece of map information is updated regardless of the timing at which the automated driving vehicle travels in the boundary area.

In the above embodiment, it has been described in FIG. 4 and the like that the traveling assist apparatus 200 includes the road information correction unit 553 in addition to the target path correction unit 552, but the traveling assist apparatus may include only the target path correction unit. The traveling assist apparatus may include a road information correction unit that corrects road information other than dividing lines and center lines, such as landmarks near roads.

In the above embodiment, an example has been described in which the target path correction unit 552 corrects the target path 110a using a function such as a Bézier curve or a B-spline curve. However, the target path correction unit that corrects the first target path on the basis of the second target path is not limited to such a configuration. The correction may be performed using another function, or the correction may be performed by geometric correction.

In the above embodiment, the example in which the deviation between the target paths generated on the plurality of maps occurs in the vehicle width direction of the vehicle 101 has been described with reference to FIGS. 3, 5A to 5C, and the like. However, the deviation occurring in the traveling direction and the height direction of the vehicle 101 can also be eliminated by a similar method.

The above embodiment can be combined as desired with one or more of the above modifications. The modifications can also be combined with one another.

According to the present invention, it becomes possible to smoothly set a target path when traveling in a boundary region of a plurality of maps.

Above, while the present invention has been described with reference to the preferred embodiments thereof, it will be understood, by those skilled in the art, that various changes and modifications may be made thereto without departing from the scope of the appended claims.

What is claimed is:

1. A traveling assist apparatus configured to support traveling of a vehicle traveling on a predetermined route along a target path, comprising:
a processor and a memory connected to the processor, wherein
the memory is configured to store a first map information of a first area and a second map information of a second area adjacent to the first area, including position information of lane marker defining a lane, wherein
the processor is configured to perform:
generating a first target path of the vehicle in the first area based on the first map information stored in the memory and generating a second target path of the vehicle in the second area based on the second map information stored in the memory; and
correcting the first target path in a boundary area between the first area and the second area based on the second target path.

2. The traveling assist apparatus according to claim 1, wherein
an accuracy of the second map information is higher than an accuracy of the first map information.

3. The traveling assist apparatus according to claim 1, wherein
the first map information is a dedicated map information that can be used by the vehicle only, wherein
the second map information is a general map information that can be used by the vehicle and other vehicles.

4. The traveling assist apparatus according to claim 1, wherein
the processor is configured to perform:
the correcting including correcting a part of the first target path as an approximate curve passing through a first point on the first target path and a second point on the second target path.

5. The traveling assist apparatus according to claim 4, wherein
one of the first point and the second point is included in a overlapped area between the first area and the second area.

6. The traveling assist apparatus according to claim 4, wherein
the first point is a point on an edge of the second area, wherein
the second point is a point on an edge of the first area.

7. The traveling assist apparatus according to claim 1, wherein
the processor is further configured to perform:
correcting position information of the lane marker stored in the memory based on a correction result of the first target path.

8. A traveling assist apparatus configured to support traveling of a vehicle traveling on a predetermined route along a target path, comprising:
a processor and a memory connected to the processor, wherein
the memory is configured to store a first map information of a first area and a second map information of a second area adjacent to the first area, including position information of lane marker defining a lane, wherein
the processor is configured to function as:
a target path generation unit configured to generate a first target path of the vehicle in the first area based on the first map information stored in the memory and configured to generate a second target path of the vehicle in the second area based on the second map information stored in the memory; and
a target path correction unit configured to correct the first target path in a boundary area between the first area and the second area based on the second target path.

9. The traveling assist apparatus according to claim 8, wherein
an accuracy of the second map information is higher than an accuracy of the first map information.

10. The traveling assist apparatus according to claim 8, wherein
the first map information is a dedicated map information that can be used by the vehicle only, wherein
the second map information is a general map information that can be used by the vehicle and other vehicles.

11. The traveling assist apparatus according to claim 8, wherein
the target path correction unit corrects a part of the first target path as an approximate curve passing through a first point on the first target path and a second point on the second target path.

12. The traveling assist apparatus according to claim 11, wherein
one of the first point and the second point is included in a overlapped area between the first area and the second area.

13. The traveling assist apparatus according to claim 11, wherein
the first point is a point on an edge of the second area, wherein
the second point is a point on an edge of the first area.

14. The traveling assist apparatus according to claim 8, wherein
the processor is further configured to function as:
a road information correction unit configured to correct position information of the lane marker stored in the memory based on a correction result of the target path correction unit.
